(19) United States
(12) Patent Application Publication
(10) Pub. No.: US 2025/0053866 A1
(43) Pub. Date: Feb. 13, 2025

(54) METHOD AND APPARATUS FOR TRAINING MACHINE LEARNING (ML) APPLICATIONS WITH A NETWORK TRAINING PLATFORM

(71) Applicant: Samsung Electronics Co., Ltd., Suwon-si (KR)

(72) Inventors: Subhash Kumar SINGH, Bangalore (IN); Sukhdeep SINGH, Bangalore (IN); Naman GUPTA, Bangalore (IN); Peter Moonki HONG, Suwon-si (KR); Seungil YOON, Suwon-si (KR)

(21) Appl. No.: 18/618,238

(22) Filed: Mar. 27, 2024

(30) Foreign Application Priority Data
Aug. 8, 2023 (IN) 202341053227

(51) Int. Cl. G06N 20/00

(52) U.S. Cl. CPC G06N 20/00

(57) ABSTRACT

A method for sharing data between machine learning (ML) applications with a network training platform. The method includes: receiving a request to register a first ML application with the network training platform, wherein the request comprises first one or more parameters related to the first ML application; identifying at least one second ML application registered with the network training platform based on the first one or more parameters; identifying second one or more parameters related to the at least one second ML application; comparing the first one or more parameters with the second one or more parameters related to the at least one second ML application; and sharing, with the first ML application, predicted data corresponding to the at least one second ML application based on the comparing.

### CROSS-REFERENCE TO RELATED APPLICATIONS

This application is based on and claims priority under 35 U.S.C. § 119 to Indian Patent Application number 202341053227, filed on Aug. 8, 2023, in the Indian Patent Office, the disclosure of which is incorporated by reference herein in its entirety.

### BACKGROUND

### Field

The disclosure relates to Machine Learning (ML) applications, and for example, relates to a method and an apparatus for training ML applications with a network training platform.

### Description of Related Art

With the advancements in telecommunications, the demand for faster data transmission, lower latency, and improved connectivity has led to the development of Beyond 5^{th} Generation (B5G) networks. B5G networks aim to overcome the limitations of previous generations of mobile networks, such as 4G, by incorporating advanced technologies like network slicing, massive MIMO (Multiple-Input Multiple-Output), and edge computing. In B5G networks, network operators face several challenges that require advanced solutions. These challenges include managing dynamic network resources, optimizing network performance, ensuring robust security, handling massive amounts of data, and adapting to rapidly changing user demands.

Given these challenges, Machine Learning (ML) applications have emerged as a powerful tool for network operators to address the challenges in B5G networks. Due to open standards in telecommunications technology, multiple network service providers have introduced network-specific ML applications and deployed the same in the same network. Moreover, there exists no platform which keeps a check on the intersecting vision and requirements of multiple ML applications being deployed on the same network. This leads to the scenario where the same operation is performed by different ML applications simultaneously over the same network leading to severe wastage of ML resources. Specifically, there are various ML applications which require training on the same set of parameters. However, as conventional techniques fail to enable context-sharing among such ML applications, each of such ML applications is trained on the same data parallelly, leading to wastage of ML resources at the network. Further, performing repetitive training of the ML applications leads to the degradation of network performance. Furthermore, the degradation of network performance affects the control and management of the network, and delays in decision-making corresponding to network management operations. Also, the wastage of ML resources of the network affects QoS of the network and also increases the overall cost of the network.

Accordingly, there is a need to address the above-mentioned problems associated with the management of ML applications.

### SUMMARY

According to an example embodiment of the present disclosure, a method for sharing data between machine learning (ML) applications with a network training platform is disclosed. The method includes: receiving a request to register a first ML application with the network training platform, wherein the request comprises first one or more parameters related to the first ML application; identifying at least one second ML application registered with the network training platform based on the first one or more parameters; identifying second one or more parameters related to the at least one second ML application; comparing the first one or more parameters with the second one or more parameters related to the at least one second ML application; and sharing, with the first ML application, predicted data corresponding to the at least one second ML application based on the comparison.

According to an example embodiment of the present disclosure, an apparatus for a network training platform for sharing data between machine learning (ML) applications is disclosed. The apparatus includes a memory storing instructions and at least one processor configured to, when executing the instructions, cause the apparatus to perform operations. The operations comprise: receiving a request to register a first ML application with the network training platform, wherein the request comprises first one or more parameters related to the first ML application; identifying at least one second ML application registered with the network training platform based on the first one or more parameters; identifying second one or more parameters related to the at least one second ML application; comparing the first one or more parameters with the second one or more parameters related to the at least one second ML application; and sharing, with the first ML application, predicted data corresponding to the at least one second ML application based on the comparison.

According to an example embodiment of the present disclosure, a-transitory computer readable storage medium storing instructions is disclosed. The instructions, when executed by at least one processor of an apparatus for a network training platform for sharing data between machine learning (ML) applications, cause the apparatus to perform operations. The operations comprise: receiving a request to register a first ML application with the network training platform, wherein the request comprises first one or more parameters related to the first ML application; identifying at least one second ML application registered with the network training platform based on the first one or more parameters; identifying second one or more parameters related to the at least one second ML application; comparing the first one or more parameters with the second one or more parameters related to the at least one second ML application; and sharing, with the first ML application, predicted data corresponding to the at least one second ML application based on the comparison.

To further clarify various advantages and features of the present disclosure, a more particular description of various example embodiments will be rendered by reference to specific embodiments thereof, which are illustrated in the appended drawings. It is appreciated that these drawings depict example embodiments of the disclosure and are therefore not to be considered limiting of its scope. Various example embodiments will be described and explained with additional specificity and detail with the accompanying drawings.

### BRIEF DESCRIPTION OF THE DRAWINGS

These and other features, aspects, and advantages of certain embodiments the present disclosure will be more apparent from the following detailed description, taken in conjunction with the accompanying drawings in which like characters represent like parts throughout the drawings, an in which:

FIG. 1 is a diagram illustrating an example environment for training Machine Learning (ML) applications using an integrated server over a network, according to various embodiments;

FIG. 2 is a block diagram illustrating an example configuration of the integrated server, according to various embodiments;

FIG. 3 is a signal flow diagram illustrating example operations for training the ML applications using the integrated server over the network, according to various embodiments;

FIGS. 4A and 4B are diagrams illustrating example scenarios for training the ML applications using the integrated server, according to various embodiments; and

FIG. 5 is a flowchart illustrating an example method for training the ML applications using the integrated server, according to various embodiments.

Further, skilled artisans will appreciate that elements in the drawings are illustrated for simplicity and may not have necessarily been drawn to scale. For example, the flowcharts illustrate the method in terms of steps involved to improve understanding of aspects of the present disclosure. Furthermore, in terms of the construction of the device, one or more components of the device may have been represented in the drawings by conventional symbols, and the drawings may show only those specific details that are pertinent to understanding the various example embodiments o as not to obscure the drawings with details that will be readily apparent to those of ordinary skill in the art having the benefit of the description herein.

### DETAILED DESCRIPTION

Reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory and are not intended to be restrictive.

Reference throughout this disclosure to “an aspect”, “another aspect” or similar language may refer, for example, to a particular feature, structure, or characteristic described in connection with an embodiment being included in at least one embodiment of the present disclosure. Thus, appearances of the phrase “in an embodiment”, “in another embodiment” and similar language throughout this disclosure may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The present disclosure is generally directed to a method of training Machine Learning (ML) applications with a network training platform. For example, the present disclosure discloses a method that compares the training requirements of the ML applications from different network operators and shares predicted/training data corresponding to one ML application with another ML application based on the comparison. Thus, the present disclosure reduces the number of ML resources required to train multiple ML applications from different network operators.

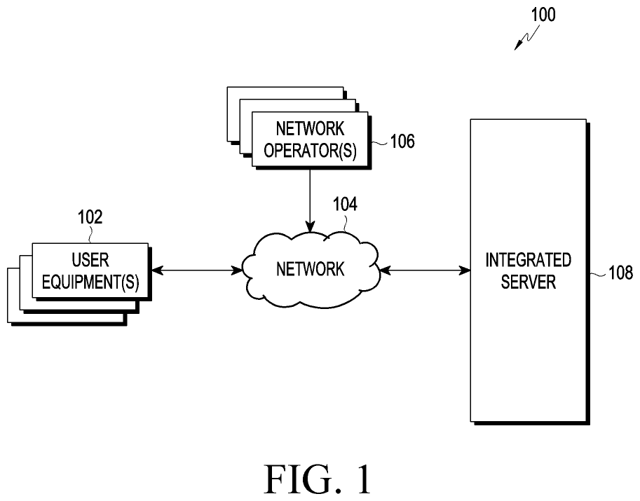

FIG. 1 is a diagram illustrating an example environment for training Machine Learning (ML) applications using an integrated server over a network, according to various embodiments. FIG. 1 illustrates a plurality of User Equipment (UEs) 102, a plurality of network operators 106, and an integrated server 108 communicably coupled with each other via a network 104. In an embodiment, the integrated server 108 may also be referred to a system for training ML applications.

The UE 102 may correspond to an end-user device that enables a user to connect to the network 104 and avail services provided by the network operators 106. Examples of the UE 102 may include, a smartphone, a tablet, a laptop, a personal computing device, and so forth. The UE 102 may be configured to interact with the network 104 and/or the associated network infrastructure, such as the integrated server 108 to enable the user to access services and/or functionalities of the network 104. Some of the functions of the UE 102 may include, but is not limited to, accessing the network 104, data transmission and reception, communicating with other entities of the network 104, handover and mobility, authentication and security, Quality of Service (QoS), power management, and so forth. In an embodiment, the network operator 106 may assist the UE 102 to perform functionality as discussed above.

The network operator 106 may correspond to an entity or system responsible for operating and managing the network 104 and/or associated services. In an embodiment, the network operator 106 may perform functions such as, but not limited to, network planning, network deployment, network maintenance, QoS, security management, network upgrades, service provisioning, performance optimization, and so forth. To implement one or more of the above-mentioned functionalities, the network operator 106 may deploy one or more Machine Learning (ML) applications via the integrated server 108. In general, the environment may include multiple network operators 106. Therefore, each of such network operators 106 may deploy one or more ML applications over the network 104 to perform the desired operations.

For example, the network operators 106 may deploy ML applications on the network 104 to improve network management, performance, and user experience. In an embodiment, the ML application may assist the network operator 106 to perform network optimization. For example, the ML application may analyze a large amount of network data, identify patterns, and optimize the network parameters to enhance performance, reliability, and efficiency of the network 104. In another example, the ML application may assist the network operator 106 to perform anomaly detection and security. For instance, the ML application may detect unusual patterns or anomalies in traffic over the network 104 to indicate a security breach, a potential threat, and so forth. Similarly, the network operators 106 may deploy various other ML applications to perform functions such as, but not limited to, QoS improvement, network traffic management, resource allocation, customer experience enhancement, predictive analytics for planning, energy efficiency, automation, and the like. In an embodiment, each of the network operators 106 may employ a specific application for a corresponding function. Moreover, there are instances when such ML applications share common training/prediction data.

The integrated server 108 may be configured to support the ML applications deployed by the network operators 106. The integrated server 108 may be configured to provide a platform to coordinate with different network operators 106 to deploy the corresponding ML applications deployed over the network 104. For example, the integrated server 108 may be configured to record a request to register a new ML application from the network operator 106. The integrated server 108 may be configured to determine whether the request corresponds to any of the previous requests made by any of the network operators 106. In a case when the request corresponds to a fresh application/new application, the integrated server 108 may register the ML application and initialize the ML training/prediction process. Further, the integrated server 108 may be configured to store ML applications and corresponding training/prediction data at a predefined storage location. However, when the integrated server 108 determines that the received request is similar to an existing ML application deployed over the network 104, the integrated server 108 may fetch matching KPIs/trained/predicted data and the respective locations to deploy the new ML application in accordance with the fetched KPs/trained/prediction data. In various embodiments, the integrated server 108 may also determine whether the prediction/training data corresponding to one application can be shared with another application based on a policy associated with said application, before sharing the same data to the other application. The operations of the integrated server 108 have been explained in detail in the following description.

The network 104 may correspond to a 5th Generation (5G) network. The network 104 may correspond to network components such as a base station. The term base station may generally refer to a fixed station that communicates with the UE 102 and/or other base stations. For example, the base station may exchange data and control information by communicating with the UE 102 and/or other base stations. For example, the base station may also be referred to as a Node B, an evolved-Node B (eNB), a next generation Node B (gNB), a sector, a site, a Base Transceiver System (BTS), an Access Point (AP), a relay node, a Remote Radio Head (RRH), a Radio Unit (RU), a small cell, or the like. In the present disclosure, a base station or a cell may be interpreted in a comprehensive sense to indicate some area or function covered by a Base Station Controller (BSC) in Code Division Multiple Access (CDMA), a Node-B in Wideband CDMA (WCDMA), an eNB in Long Term Evolution (LTE), a gNB or sector (site) in 5G, and the like, and may cover all the various coverage areas such as megacell, macrocell, microcell, picocell, femtocell, and relay node, and so forth.

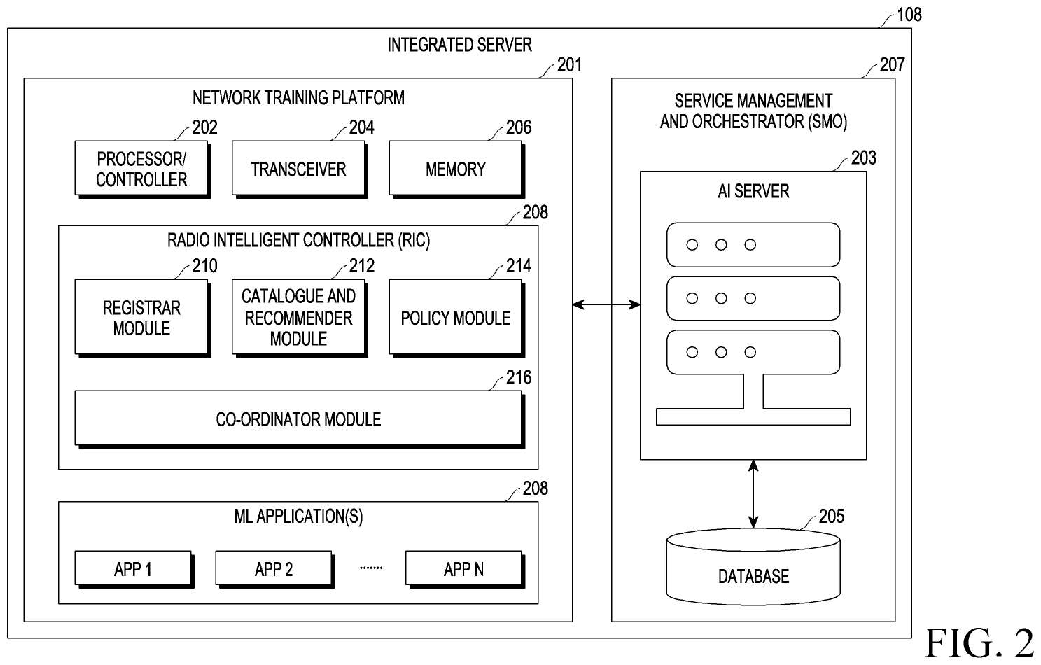

FIG. 2 is a block diagram illustrating an example configuration of the integrated server 108, according to various embodiments. The integrated server 108 includes a network training platform 201, an Artificial Intelligence (AI) server 203, and a database 205. The AI server 203 and the database 205 may be a part of a Service Management and Orchestrator (SMO) 207.

The network training platform 201 includes a processor/controller (e.g., including processing circuitry) 202, a transceiver 204, a memory 206, a Radio Intelligent Controller (RIC) 208, and one or more ML applications 218. The processor/controller 202 may include specialized processing units such as, but not limited to, integrated system (bus) controllers, memory management control units, floating point units, digital signal processing units, etc. In one embodiment, the processor/controller 202 may include a central processing unit (CPU), a Graphics Processing Unit (GPU), or both. The processor/controller 202 may be one or more general processors, Digital Signal Processors (DSPs), Application-Specific Integrated Circuits (ASIC), field-programmable gate arrays, servers, networks, digital circuits, analog circuits, combinations thereof, or other now-known or later developed devices for analyzing and processing data. The processor/controller 202 may execute a software program, such as code generated manually (e.g., programmed) to perform the desired operation. The processor/controller 202 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor/controller 202 may be disposed in communication with the network 104 via the transceiver 204. The transceiver 204 may act as a network interface for the processor/controller 202. In various embodiments, the transceiver 204 may include inference that may employ communication code-division multiple access (CDMA), high-speed packet access (HSPA+), global system for mobile communications (GSM), long-term evolution (LTE), WiMax, or the like, etc.

In various embodiments, the transceiver 204 may include various communication circuitry and be implemented with a network interface to employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network may include, without limitation, a direct interconnection, Local Area Network (LAN), Wide Area Network (WAN), wireless network (e.g., using Wireless Application Protocol), the Internet, etc. Using the network interface and the communication network, the integrated server 108 and/or network training platform 201 may communicate with the network 104, the UEs 102, and/or the network operators 106.

The processor/controller 202 may also be communicably coupled with the memory 206. The memory 206 may be configured to store data, and instructions executable by the processor/controller 202 to perform the method(s) disclosed herein. In one embodiment, the memory 206 may communicate via a bus within the network training platform 201. The memory 206 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media, and the like. In an example, the memory 206 may include a cache or random-access memory for the processor/controller 202. In alternative examples, the memory 206 is separate from the processor/controller 202, such as a cache memory of a processor, the system memory, or other memory. The memory 206 may be an external storage device or database for storing data. The memory 206 may be operable to store instructions executable by the processor/controller 202. The functions, acts or tasks illustrated in the figures or described may be performed by the programmed processor/controller 202 for executing the instructions stored in the memory 206. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

The processor/controller 202 in communication with the transceiver 204 and the memory 206 may be configured to implement the ML applications 218 over the network 104. The processor/controller 202 may be configured to train the ML applications 218 to implement the desired functionality of the corresponding ML applications 218. In an embodiment, the memory 206 may be configured to store ML applications 218 and/or associated training/prediction data. In various embodiment, one or more functions/operations of the processor/controller 202 may be performed by the RIC 208 via a plurality of modules.

The RIC 208 may include the plurality of modules, each including, for example, executable program instructions, required to implement one or more functionality of the network training platform 201. For example, the RIC 208 includes a registrar module 210, a catalogue and recommender module 212 (interchangeably referred to as the catalogue module 212), a policy module 214, and a coordinator module 216. The RIC 208 may be configured to register ML applications 218 on the network training platform 201 to train the ML applications to predict the desired data.

The registrar module 210 may be configured to receive a request to register from the ML applications 218. In illustrated embodiment, the ML applications 218 have been included in the integrated server 108, however embodiments intend to cover any other suitable location of the ML applications 218. For instance, ML applications 218 may be located at a remote location outside the integrated server 108. For instance, the registrar module 210 receives the request from “App1” of the ML applications 218. The request may include one or more parameters corresponding to training requirements of the corresponding ML application. Examples of such parameters may include, but not limited to, identification, slice identification, site identification, Key Performance Indicator (KPI) to train, timestamp of data to use, an accuracy of predicted data, an identification of a ML model associated with the ML application, and so forth. In an embodiment, the request to register the ML application may be transmitted by the network operator 106 of the corresponding ML application.

For instance, the App 1 may correspond to a network performance prediction application. Therefore, the request corresponding to App 1 may include slice identification that may indicate a slice such as, voice, video, data, etc., for which performance prediction is required. Further, the request may include site indications that may identify a network site or a location for which the performance prediction is required. The request may further include KPIs to train specific network KPIs for performance prediction that are relevant to the identified network slice and site. Examples of such KPIs may include, but are not limited to, latency, throughput, packet loss, jitter, and so forth. Moreover, the request may include a timestamp of data to use which indicates data range and corresponding time period that need to be used for performance prediction. The request may also indicate the desired accuracy of predicted data. For instance, the ML application may require high accuracy, such as 95% or above, in predicting the KPIs associated with the network. Another important parameter which may be included in the request of the ML application may correspond to the identification of the ML model. Specifically, the ML application may indicate a most suitable ML model architecture for the desired prediction. For example, the App 1 may indicate the relevant ML model architecture for network performance prediction. Examples of such ML model architectures include, but are not limited to, regression models, ensemble models, time-series models, and so forth.

Embodiments are merely examples, and the request may include any suitable parameters corresponding to the ML application that are required by the ML application to perform the desired prediction.

Upon receiving the request from the ML application (App1), the registrar module 210 may coordinate with the catalogue and recommender module 212 to determine whether there is any ML application which has been registered over the network training platform 201 with the same training requirement as specified by App1 in the request to register. The App1 may also be referred to as the first ML application. For a new application with a unique training requirement, the registrar module 210 in coordination with the catalogue and recommender module 212 may not find any similar ML application. The registrar module 210 and/or the catalogue and recommender module 212 may compare each of the parameters specified in the request to register with parameters stored corresponding to a plurality of already registered ML applications. The plurality of already registered ML applications may also be referred to as a plurality of second ML applications. For instance, the plurality of second ML applications may include App-2 to App-n. In an embodiment, the registrar module 210 and/or the catalogue and recommender module 212 may compare each parameter of the request to register with the corresponding parameters of the second ML application and upon determining the exact match of each of the parameters of the first ML application and at least one of the second ML application, the registrar module 210 and/or the catalogue and recommender module 212 may classify the second ML application as similar to the first ML application. The registrar module 210 and/or the catalogue and recommender module 212 may classify the second ML application as similar to the first ML application upon determining a match of one or more of the plurality of parameters corresponding to the first ML application and the second ML application.

In an embodiment, when the registrar module 210 identifies the first ML application as a new application with a unique training requirement, the registrar module 210 registers the first ML application with the network training platform 201. The registrar module 210 may also transmit an acknowledgement indicating the successful registration of the first ML application with the network training platform 201 to the first ML application and/or the corresponding network operator 106.

Upon successful registration, the network training platform 201 may train the first ML application and update the catalogue and recommender module 212 and/or associated storage in the memory 206. Specifically, the network training platform 201 may store the first ML application, training data, and prediction data corresponding to the first ML application at predefined locations in the memory 206. The catalogue and recommender module 212 may be configured to keep track of all the registered ML applications in a format as indicated in Table 1 below:

TABLE 1

| | | | | | | | |
|---|---|---|---|---|---|---|---|
| Cell | Slice | Site | KPI/ | ACC | Model | Model | Prediction |
| | | | Parameter | | | Storage | location |
| | | | | | | Location | |

Embodiments are merely examples, and the catalogue and recommender module 212 may be configured to store any suitable information in any suitable format, as per the requirement of the network training platform 201.

In another instance, when the registrar module 210 receives a request to register from the first ML application that has training parameters matching with a second ML application. The catalogue and recommender module 212 may analyze the historical data and precomputes corresponding to the second ML application and share the predicted/training data corresponding to the second ML application with the first ML application. Alternatively, the registrar module 210 in combination with the catalogue and recommender module 212, may initiate training of the first ML application based on the predicted/training data corresponding to the second ML application.

In various embodiments, prior to sharing the predicted/training data with the first ML application, the registrar module 210 may communicate with the policy module 214 to fetch policy information corresponding to the second ML application. The policy information may indicate a policy/rule corresponding to sharing of the predicted/training data. For example, the policy information may indicate whether the network training platform 201 is allowed to share the predicted/training data corresponding to the second ML application with the first ML application. In an embodiment, the policy information corresponding to an ML application may be defined by the corresponding network operator 106. The policy module 214 may generate the policy information corresponding to the ML application based on one or more associated characteristics of the ML application. Such characteristics of the ML application may include, but are not limited to, a type of ML application, a severity level of ML application, and so forth. For instance, for a security ML application corresponding to a specific network operator, the policy module 214 may define policy indicating that the training/prediction data corresponding to the security ML application may not be shared with any ML application.

Upon successful validation of the policy, the coordinator module 216 may be configured to communicate with SMO 207, e.g., the AI server 203 and/or the database 205, to extract/pull the prediction/training data corresponding to at least one second ML application. Further, the registrar module 210 may be configured to return the response to the first ML application, with the extracted prediction/training data corresponding to the second ML application.

The SMO 207 provides a platform to automate necessary operations of the network 104. The SMO 207 may enable the network operators 106 to automate tasks in the network 104 to reduce costs and increase productivity. The SMO 207 includes the AI server 203 and the database 205.

The AI server 203 may correspond to a specialized server infrastructure configured to handle ML tasks/operations related to the network 104. The AI server 203 may leverage the power of AI and ML algorithms to optimize, automate, and secure network processes at the network 104. The AI server 203 in communication with the network training platform 201 may support implementation of the ML applications as discussed herein. For example, the AI server 203 may include substantial computational resources and data storage capabilities to execute ML models corresponding to the ML applications. The AI server 203 may process and/or execute the ML models either in real-time or in batch processing. Moreover, the AI server 203 may also be trained regularly to ensure the accuracy and effectiveness of the AI server 203.

The database 205 may be configured to act as a repository for the ML models corresponding to the registered ML applications and/or the AI server 203. Further, the database 205 may correspond to the repository for the prediction/training data corresponding to the ML models and/or the ML applications implemented on the network 104. In an embodiment, the database 205 may act as a structured collection of data that is organized, stored, and managed in a way that allows for efficient retrieval, manipulation, and updating of information.

Further, the disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processor/controller 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection or may be established wirelessly. The network may alternatively be directly connected to the bus. For the sake of brevity, the architecture and standard operations of the processor/controller 202, the transceiver 204, and the memory 206 are not discussed in detail.

Further, one or more components of the integrated server 108 may be implemented through an AI model. A function associated with AI may be performed through the non-volatile memory, the volatile memory, and the processor.

The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Being provided through learning may refer, for example, to, by applying a learning technique to a plurality of learning data, a predefined operating rule or AI model of a desired characteristic being made. The learning may be performed in a device itself in which AI according to an embodiment is performed, and/or may be implemented through a separate server/system.

The AI model may include a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique may refer, for example, to a method for training a predetermined target device (for example, a robot) using a plurality of learning data to cause, allow, or control the target device to decide or predict. Examples of learning techniques include, but are not limited to, supervised learning, unsupervised learning, semi-supervised learning, or reinforcement learning.

According to the disclosure, in a method training ML applications with the network training platform 201, the processor may perform a pre-processing operation on the data to convert it into a form appropriate for use as an input for the artificial intelligence model. The artificial intelligence model may be obtained by training. Here, “obtained by training” may refer, for example, to a predefined operation rule or artificial intelligence model configured to perform a desired feature (or purpose) being obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction may refer, for example, to a technique of logical reasoning and predicting by determining information and includes, e.g., knowledge-based reasoning, optimization prediction, preference-based planning, or recommendation.

In an embodiment, the integrated server 108 may be implemented as a stand-alone server communicably coupled to other components of the network 104. In an embodiment, the integrated server 108 may be implemented at an Element Management System (EMS).

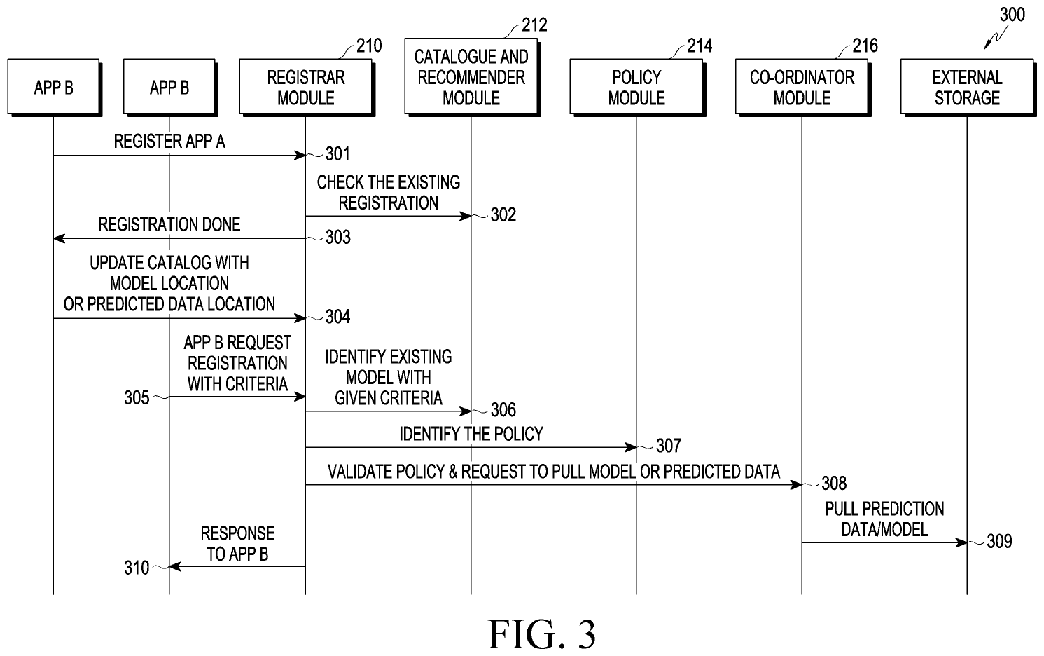

FIG. 3 is a signal flow diagram 300 illustrating example operations for training the ML applications using the integrated server 108 over the network 104, according to various embodiments. The process flow 300 indicates the registration of two different ML applications, e.g., App A and App B, over the network training platform 201. For example, at step 301, App A transmits a request to register over the network training platform 201 to the registrar module 210. At step 302, the registrar module 210 communicates with the catalogue and recommender module 212 to determine an existing registration similar to the request to register from App A. Upon determining that no existing similar registration exists, the registrar module 210 registers App A over the network training platform 201 and transmits an acknowledgement indicating successful completion of registration, as step 303. Next in step 304, the App A completes the training and updates the registrar module 210 with a location of the ML model used by the App A, and corresponding training/prediction data. At step 305, the App B transmits a request to register over the network training platform 201 to the registrar module 210. At step 306, the registrar module 210 may identify a context of the request from the App B to determine if there exists an ML model and/or training/prediction data with the catalogue module 212 corresponding to the identified context. At step 307, upon determining an existing ML model and/or training/prediction data corresponding to the request of the App B, the registrar module 210 may communicate with the policy module 214 to identify a policy of sharing corresponding to the identified ML model and/or the training/prediction data. Further, the registrar module 210 may be configured to validate the identified policy of sharing. At step 308, upon successful validation of the identified policy, the registrar module 210 may communicate with the coordinator module 216 to fetch the identified ML model and/or the training/prediction data. At step 309, the coordinator module 216 may extract/pull the identified ML model and/or the training/prediction data from an external storage (for example, the AI server 203, and/or the database 205). At step 310, the registrar module 210 shares the response to the App B that includes the extracted ML model and/or the training/prediction data.

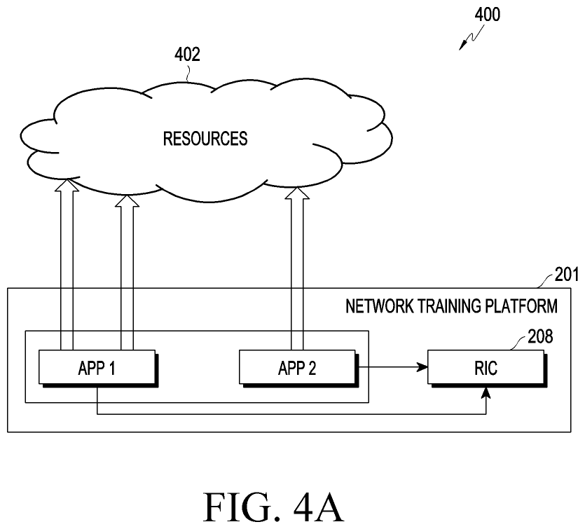

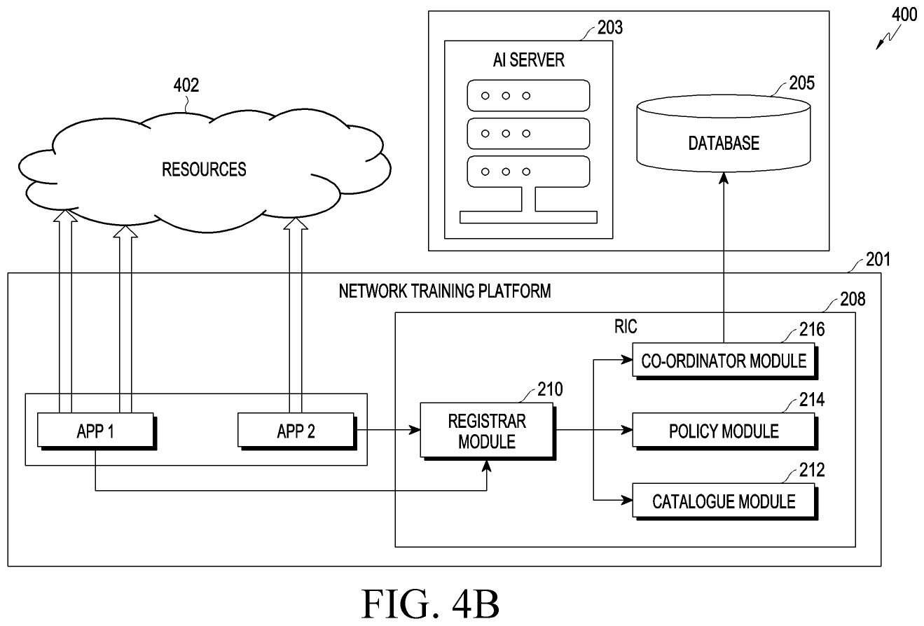

FIGS. 4A and 4B are diagrams illustrating example scenarios 400 for the training of the ML applications using the integrated server 108, according to various embodiments. For example, FIG. A illustrates two ML applications, e.g., App 1 and App 2 being implemented on the network training platform 201. In an embodiment, App 1 and App 2 may correspond to App A and App B, respectively, as discussed in FIG. 3. In an embodiment, the App 1 corresponds to the QoS prediction application that is configured to predict QoS over the network 104 (shown in FIG. 1). In an embodiment, the App 1 may be implemented by a first network operator. The App 1 requires training on parameters such as, Reference Signal Received Power (RSRP) and Reference Signal Received Quality (RSRQ) to predict the quality and strength of radio signals between a UE 102 and the network 104/a base station. The App 2 corresponds to a scheduler application that is configured to manage radio resources and optimize the allocation of said resources to different UEs 102 and/or services. In an embodiment, the App 2 may be implemented by a second network operator. Further, the App 2 requires training on parameters including, RSRQ, RSRP, and throughput to predict radio resources and corresponding allocations to the different UEs 102 and/or the services. Since two parameters of App 1 and App 2 are the same, the network training platform 201 may configure the App 1 to request training on the requested parameters and configure the App 2 to request training on parameter(s) which are distinct from the parameters of the App 1, for example, throughout, using resources 402. The resources 402 may correspond to one or more components/resources of the network training platform 201, the network 104, and/or the integrated server 108.

Once the App 1 and App 2 are trained on the requested parameters, the network training platform 201 may provide the training/prediction data corresponding to parameters RSRP and RSRQ of the App 1 with the App 2, such that App 2 can perform the desired operation. Therefore, instead of separately training the App 1 and the App 2 on the same parameters that leads to wastage of resources 402, the network training platform 201 trains the App 1 and the App 2 by effective and efficient utilization of the resources 402.

FIG. 4B illustrates the specific implementation of the RIC 208 to achieve the discussed advantage. For instance, as a first step, the App 1 requests the registrar module 210 to register the App 1 with the required parameters on the network training platform 201. Further, upon successful registration and training, the App 1 updates the registrar module 210 with a location of a ML model and the training/prediction data corresponding to the App 1. The catalogue module 212 may be configured to store a record of all the ML applications along with corresponding criteria registered over the network training platform 201. Next, the App 2 requests the registrar module 210 to register the App 2 on the network training platform 201 with specific parameters associated with the App 2. Upon receiving the request from the App 2, the registrar module 210 in coordination with the catalogue module 212 matches the parameters corresponding to the App 2 with stored parameters at the network training platform 201. Upon identifying matching parameters, the registrar module 210 provides the stored training/prediction data to the App 2. Thereafter, the App 2 utilizes the received training/prediction data for the matching parameters, and requests training only for the distinct parameter, e.g., the throughput.

However, prior to sharing the stored training/prediction data, the RIC 208 may perform various operations such as, matching the parameters corresponding to the App 2 with pre-stored parameters corresponding to the already registered application(s), such as the App 2. The RIC 208 may further coordinate with the policy module 214 to validate the policy for sharing the training/prediction data corresponding to the application having similar parameters as compared to the parameters of the App 2. Further, the RIC 208 in coordination with the catalogue module 212 may fetch the relevant training/prediction data from a remote server (for example, the AI server 203) and/or the database 205 based on the location information stored with the catalogue module 212. Thus, the RIC 208 effectively implements and efficiently trains different ML applications on the network training platform 201.

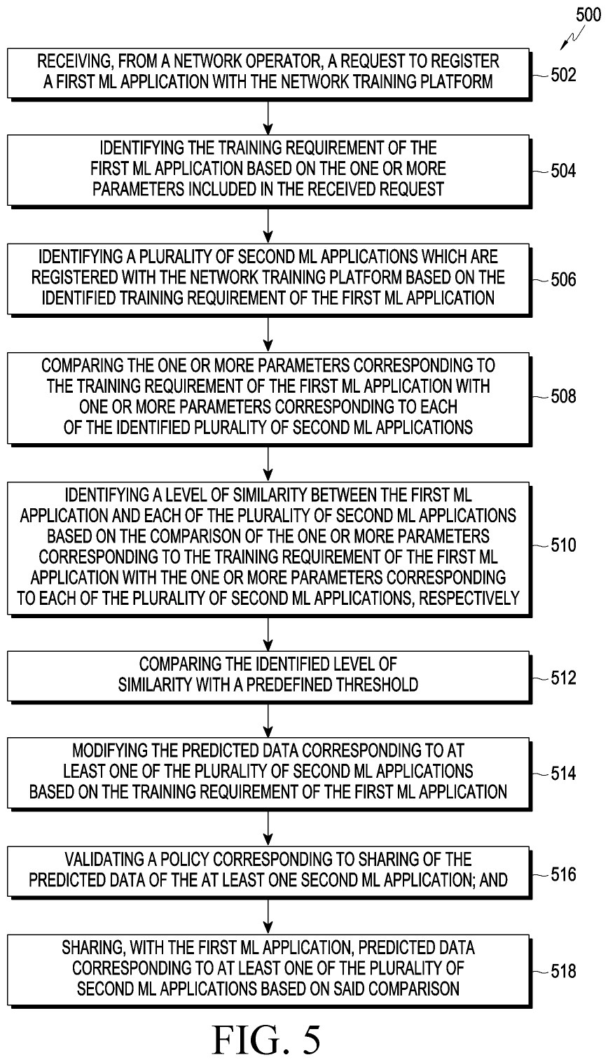

FIG. 5 is a flowchart illustrating an example method for training the ML applications using the integrated server, according to various embodiments. The method 500 may be implemented by the integrated server 108 and/or the associated components, as explained in reference to FIGS. 1-4B.

At step 502, the method 500 includes receiving a request to register a first ML application with the network training platform 201 from the network operator 106. The request may include one or more parameters corresponding to a training requirement of the first ML application. In an embodiment, the one or more parameters corresponding to the training requirement of the first ML application may include, but are not limited to, cell identification, slice identification, site identification, Key Performance Indicator (KPI) to train, timestamp of data to use, an accuracy of predicted data, and the identification of the ML model associated with the first ML application. At step 504, the method 500 includes identifying the training requirement of the first ML application based on the one or more parameters included in the received request.

At step 506, the method 500 includes identifying a plurality of second ML applications which are registered with the network training platform 201 based on the identified training requirement of the first ML application.

At step 508, the method 500 includes comparing the one or more parameters corresponding to the training requirement of the first ML application with one or more parameters corresponding to each of the identified plurality of second ML applications. At step 510, the method 500 includes identifying a level of similarity between the first ML application and each of the plurality of second ML applications based on the comparison of the one or more parameters corresponding to the training requirement of the first ML application with the one or more parameters corresponding to each of the plurality of second ML applications, respectively.

At step 512, the method 500 includes comparing the identified level of similarity with a predefined (e.g., specified) threshold to determine whether to share the predicted data corresponding to the at least one second ML application with the first ML application. In an embodiment, the method 500 may include sharing the predicted data corresponding to at least one of the plurality of second ML applications with the first ML application, upon determining that the level of similarity between the first ML application and the at least one second ML application is greater than the predefined threshold. Further, upon determining that the level of similarity between the first ML application and the plurality of second ML applications is less than the predefined threshold, the method 500 may include training the first ML application to obtain predicted data corresponding to the training requirement of the first ML application.

At step 514, the method 500 includes modifying the predicted data corresponding to the at least one of plurality of second ML applications based on the training requirement of the first ML application. In an embodiment, the method may include transmitting, to the at least one of plurality of second ML applications, a request to modify the predicted data corresponding to the at least one of plurality of second ML applications based on the training requirement of the first ML application.

At step 516, the method 500 includes validating a policy corresponding to sharing of the predicted data of the at least one second ML application.

At step 518, the method 500 includes sharing, with the first ML application, predicted data corresponding to at least one of the plurality of second ML applications based on said comparison and successful validation of the policy.

While the above-discussed operations in FIG. 5 are shown and described in a particular sequence, the steps may occur in variations to the sequence in accordance with various embodiments.

The present disclosure may enable the effective and efficient implementation of ML applications over the network. For example, the present disclosure enables ML applications implemented over the network to coordinate and share ML resources in a better-optimized way. Further, the present disclosure prevents and/or reduces repetitive training on the same data for similar requirements that result in performance improvement of the network training platform. Further, the present disclosure improves the performance of the network by improving the performance of individual ML applications over the network. Moreover, the present disclosure enables ML applications from different network operators to share context (ML model/prediction data) and avoid any additional computational costs.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for sharing data between machine learning (ML) applications by a network training platform, the method comprising:
receiving a request to register a first ML application with the network training platform, wherein the request comprises first one or more parameters related to the first ML application;
identifying at least one second ML application registered with the network training platform based on the first one or more parameters;
identifying second one or more parameters related to the at least one second ML application;
comparing the first one or more parameters with the second one or more parameters related to the at least one second ML application; and
sharing, with the first ML application, predicted data corresponding to the at least one second ML application based on the comparing.

2. The method of claim 1, wherein the first one or more parameters comprises at least one of cell identification, slice identification, site identification, key performance indicator (KPI) to train, timestamp of data to use, an accuracy of predicted data, and an identification of a ML model associated with the first ML application.

3. The method of claim 1, comprising:
identifying a level of similarity between the first ML application and the at least one second ML application based on the comparison of the first one or more parameters with the second one or more parameters;
comparing the identified level of similarity with a specified threshold; and
sharing, with the first ML application, the predicted data corresponding to the at least one second ML application based on the level of similarity between the first ML application and the at least one second ML application being greater than the specified threshold.

4. The method of claim 1, further comprising:
prior to sharing the predicted data corresponding to the at least one second ML application with the first ML application, modifying the predicted data based on the first one or more parameters.

5. The method of claim 1, further comprising:
transmitting, to the at least one second ML application, a request to modify the predicted data corresponding to the at least one second ML application based on the first one or more parameters.

6. The method of claim 3, comprising:
training the first ML application, to obtain predicted data corresponding to the first one or more parameters of the first ML application based on the level of similarity between the first ML application and the at least one second ML application being less than the specified threshold.

7. The method of claim 1, wherein sharing the predicted data corresponding to the at least one the second ML application based on the comparing comprises:
validating a policy corresponding to sharing of the predicted data of the at least one second ML application; and
sharing the predicted data of the at least one of the plurality of second ML applications based on successful validation of the policy.

8. An apparatus for a network training platform for sharing data between machine learning (ML) applications, comprising:
a memory storing instructions; and
at least one processor configured to, when executing the instructions, cause the apparatus to perform operations comprising:
receiving a request to register a first ML application with the network training platform, wherein the request comprises first one or more parameters corresponding related to the first ML application;
identifying at least one second ML application registered with the network training platform based on the first one or more parameters;
identifying second one or more parameters related to the at least one second ML application;
comparing the first one or more parameters with the second one or more parameters related to the at least one second ML application; and
sharing, with the first ML application, predicted data corresponding to the at least one second ML application based on the comparing.

9. The apparatus of claim 8, wherein the first one or more parameters comprises at least one of cell identification, slice identification, site identification, key performance indicator (KPI) to train, timestamp of data to use, an accuracy of predicted data, and an identification of a ML model associated with the first ML application.

10. The apparatus of claim 8, wherein the operations comprises:
identifying a level of similarity between the first ML application and the at least one second ML application based on the comparison of the first one or more parameters with the second one or more parameters;
comparing the identified level of similarity with a specified threshold; and
sharing, with the first ML application, the predicted data corresponding to the at least one second ML application based on the level of similarity between the first ML application and the at least one second ML application being greater than the specified threshold.

11. The apparatus of claim 8, wherein the operations further comprises:
prior to sharing the predicted data corresponding to at least one second ML application, modifying the predicted data based on the first one or more parameters.

12. The apparatus of claim 8, wherein the operations further comprises:
transmitting, to the at least one second ML application, a request to modify the predicted data corresponding to the at least one second ML application based on the first one or more parameters.

13. The apparatus of claim 10, wherein the operations further comprises:
training, the first ML application, to obtain predicted data corresponding to the first one or more parameters based on the level of similarity between the first ML application and the at least one second ML application being less than the predefined threshold.

14. The apparatus of claim 8, wherein sharing the predicted data corresponding to the at least one second ML application based on the comparison comprises:
validating a policy corresponding to sharing of the predicted data corresponding to the at least one second ML application; and
sharing the predicted data corresponding to the at least one of the plurality of second ML applications based on successful validation of the policy.

15. A non-transitory computer readable storage medium storing instructions which, when executed by at least one processor of an apparatus for a network training platform for sharing data between machine learning (ML) applications, cause the apparatus to perform operations, the operations comprising:
receiving a request to register a first ML application with the network training platform, wherein the request comprises first one or more parameters related to the first ML application;
identifying at least one second ML application registered with the network training platform based on the first one or more parameters;
identifying second one or more parameters related to the at least one second ML application;
comparing the first one or more parameters with the second one or more parameters related to the at least one second ML application; and
sharing, with the first ML application, predicted data corresponding to the at least one second ML application based on the comparing.

16. The non-transitory computer readable storage medium of claim 15, wherein the first one or more parameters comprises at least one of cell identification, slice identification, site identification, key performance indicator (KPI) to train, timestamp of data to use, an accuracy of predicted data, and an identification of a ML model associated with the first ML application.

17. The non-transitory computer readable storage medium of claim 15, wherein the operations comprises:
identifying a level of similarity between the first ML application and the at least one second ML application based on the comparison of the first one or more parameters with the second one or more parameters;
comparing the identified level of similarity with a specified threshold; and
sharing, with the first ML application, the predicted data corresponding to the at least one second ML application based on the level of similarity between the first ML application and the at least one second ML application being greater than the specified threshold.

18. The non-transitory computer readable storage medium of claim 15, wherein the operations further comprises:
prior to sharing the predicted data corresponding to at least one second ML application, modifying the predicted data based on the first one or more parameters.

19. The non-transitory computer readable storage medium of claim 15, wherein the operations further comprises:
transmitting, to the at least one second ML application, a request to modify the predicted data corresponding to the at least one second ML application based on the first one or more parameters.

20. The non-transitory computer readable storage medium of claim 17, wherein the operations further comprises:
training, the first ML application, to obtain predicted data corresponding to the first one or more parameters of the first ML application based on the level of similarity between the first ML application and the at least one second ML application being less than the predefined threshold.
